(19) United States
(12) Patent Application Publication
(10) Pub. No.: US 2026/0235253 A1
(43) Pub. Date: Aug. 13, 2026

(54) VEHICLE CALIBRATION DEVICE

(71) Applicant: SHENZHEN SMARTSAFE TECH CO., LTD., Shenzhen, Guangdon (CN)

(72) Inventors: Jun LIU, Shenzhen, Guangdong (CN); Wei ZHAN, Shenzhen, Guangdong (CN); Xinwei XU, Shenzhen, Guangdong (CN)

(21) Appl. No.: 19/471,536

(22) PCT Filed: Dec. 14, 2023
(86) PCT No.: PCT/CN2023/138766

§ 371 Date: Oct. 23, 2025

(30) Foreign Application Priority Data
Apr. 4, 2023 (CN) 202320810378.2

(51) Int. Cl. F16M 11/04; F16M 11/26; G01B 21/04

(52) U.S. Cl. CPC F16M 11/041; F16M 11/26; G01B 21/042

(57) ABSTRACT

A vehicle calibration device, including: a base; an upright frame provided on the base; a first locking mechanism provided on the upright frame; and a bracket configured to be secured to the first locking mechanism and in detachable connection with the first locking mechanism. The first locking mechanism includes a first locking structure connected to the upright frame and a first locking member. The first locking structure has a slot, the bracket has an insertion end, the first locking member is threadedly connected to the first locking structure. When the first locking member is in a locked state, the first locking member is inserted into the slot and abuts against the insertion end to secure the upright frame. When the first locking member is in an unlocked state, the first locking member is disengaged from the insertion end, allowing the upright frame to be removed from the upright frame.

### CROSS-REFERENCE TO RELATED APPLICATIONS

This application is the national phase entry of International Patent Application No. PCT/CN 2023/138766 with an international filing date of Dec. 14, 2023, which claims priority to Chinese Patent Application No. 202320810378.2, filed on Apr. 4, 2023. The entire content each of which is incorporated herein by reference.

### TECHNICAL FIELD

The present application relates to the field of vehicle calibration device, and more particularly, to a vehicle calibration device.

### BACKGROUND

Currently, the vehicle calibration device includes a lifting mechanism and a calibration bracket. The lifting mechanism adjusts the height of the calibration bracket to accommodate different types of vehicles to be calibrated. To accommodate larger calibration components, existing calibration brackets are designed to be large, and the calibration bracket occupies more space when fixed on the lifting mechanism, resulting in high difficulty in transferring the vehicle calibration device.

### SUMMARY

An objective of the present application is to provide a vehicle calibration device that addresses the technical problem in existing technologies that the calibration bracket, when attached to the lifting mechanism, occupies more space, resulting in high difficulty in transferring the vehicle calibration device.

To achieve the above objective, the present application adopts the following technical solutions:

In accordance with a first aspect, a vehicle calibration device is provided, which includes:
a base;
an upright frame provided on the base;
a first locking mechanism provided on the upright frame; and
a bracket configured to be secured to the first locking mechanism and being detachably connected to the first locking mechanism.

Herein, the first locking mechanism includes a first locking structure connected to the upright frame and a first locking member provided on the first locking structure. The first locking structure has a slot, the bracket has an insertion end for insertion into the slot, and the first locking member is threadedly connected to the first locking structure. The first locking member has a locked state and an unlocked state. When the first locking member is in the locked state, the first locking member is inserted into the slot and abuts against the insertion end to secure the upright frame. When the first locking member is in the unlocked state, the first locking member is disengaged from the insertion end, allowing the upright frame to be removed from the upright frame.

By employing the above technical solution, the vehicle calibration device can be disassembled into multiple components including the bracket and the upright frame when transferring the vehicle calibration device. This reduces the maximum weight of each component, facilitating handling and reducing the difficulty of transfer.

In one embodiment, the slot has two opposing side slot walls, and the first locking member is disposed on one of the side slot walls. When the first locking member is inserted into the slot and abuts against the insertion end, the first locking member pushes against the insertion end, pressing the insertion end against the other one of the side slot walls of the slot.

By employing the above technical solution, the relative fixation of the bracket and the upright frame is realized.

In one embodiment, an end of the first locking member that abuts against the insertion end is provided with a gasket, and the gasket is configured to abut against a surface of the insertion end.

By employing the above technical solution, the gasket increases the friction between the first locking member and the insertion end, thereby the secure locking of the first locking member against the insertion end is enhanced.

In one embodiment, an end of the first locking member facing away from the first locking structure is provided with a locking knob.

By employing the above technical solution, the operator's difficulty in operating the first locking member is reduced, physical effort is reduced, and an operation efficiency is improved.

In one embodiment, the insertion end is provided with a first locking hole that mates with the first locking member. When the first locking member is inserted into the slot, the first locking member is inserted into the first locking hole.

By employing the above technical solution, the cooperative limiting action of the first locking member and the first locking hole enables the bracket to be to secured relative to the upright frame.

In one embodiment, the end of the first locking member inserted into the first locking hole is threadedly engaged with the first locking hole.

By employing the above technical solution, the force generated by the threaded connection improves the stability of the bracket when the bracket is secured to the upright frame.

In one embodiment, the vehicle calibration device also includes a second locking mechanism. The second locking mechanism and the first locking mechanism are arranged sequentially along a length direction of the upright frame. The second locking mechanism includes a second locking structure provided on the upright frame and a locking block provided on the upright frame. The second locking structure has a slide groove, and the locking block is configured to slide into the slide groove to securely connect the bracket to the upright frame.

By employing the above technical solution, the first and second locking mechanisms simultaneously securely connect the bracket and the upright frame, reducing the possibility of the bracket flipping around the first locking mechanism due to the bracket's own weight when secured to the first locking mechanism.

In one embodiment, the slide groove is a T-shaped groove, a C-shaped groove, a 7-shaped groove, or a circular groove. A shape of the locking block matches that of the slide groove, allowing the locking block to slide into the slide groove.

By employing the above technical solution, the locking block and the slide groove can fit together well.

In one embodiment, the second locking mechanism also includes a latch lock provided on the second locking structure. The latch lock includes a latch seat and a latch retractable from the latch seat. The latch is insertable into the second locking hole of the locking block.

By employing the above technical solution, the possibility of the locking block loosening from the second locking structure is reduced.

In one embodiment, the latch lock also includes an elastic member connecting the latch seat and the latch, the elastic member is configured to drive the latch to be inserted into the second locking hole.

By employing the above technical solution, the latch is allowed to automatically insert into the second locking hole when the locking block is inserted into the slide groove, eliminating the need for operator intervention and improving the efficiency of bracket assembly on the upright frame.

### BRIEF DESCRIPTION OF THE DRAWINGS

To more clearly illustrate the technical solutions in the embodiments of the present application, a brief introduction to the drawings required for the embodiments will be provided below. It is obvious that the drawings described below are merely some embodiments of the present application. For those of ordinary skill in the art, other drawings can also be obtained based on these drawings without exerting creative efforts.

FIG. 1 is a three-dimensional structural diagram of the vehicle calibration device provided in an embodiment of the present application;

FIG. 2 is an exploded view (I) of the vehicle calibration device provided in an embodiment of the present application;

FIG. 3 is an exploded view (II) of the vehicle calibration device provided in an embodiment of the present application;

FIG. 4 is an exploded view of a first locking mechanism provided in an embodiment of the present application; and

FIG. 5 is an exploded view of a second locking mechanism provided in an embodiment of the present application.

Reference numerals in the figures are listed as follows:

100, vehicle calibration device;

1, base; 2, upright frame; 3, first locking mechanism; 4, bracket; 5, second locking mechanism;

31, first locking structure; 32, first locking member; 41, insertion end; 51, second locking structure; 52, locking block; 53, latch lock;

311, slot; 321, gasket; 322, locking knob; 511, slide groove; 531, latch seat; 532, latch; 521, second locking hole; and

3111, side slot wall.

### DETAILED DESCRIPTION OF THE EMBODIMENTS

To further clarify the technical problems to be solved, technical solutions, and beneficial effects of the present application, the present application is further described below in conjunction with the drawings and embodiments. It should be understood that the specific embodiments described herein are intended solely to illustrate the present application and are not intended to limit the present application.

It should be noted that when an element is referred to as being “fixed to” or “disposed on” another element, it may be directly or indirectly located on the other element. When an element is referred to as being “connected to” another element, it may be directly or indirectly connected to the other element.

It should be understood that terms such as “length,” “width,” “upper,” “lower,” “front,” “back,” “left,” “right,” “vertical,” “horizontal,” “top,” “bottom,” “inner,” and “outer” to indicate positions or relationships are based on the positions or relationships shown in the drawings and are intended solely to facilitate the description of the present application, rather than implying that a device or element must have, be constructed, or operated in a specific orientation, and therefore should not be construed as limiting the present application.

Furthermore, the terms “first” and “second” are used solely for descriptive purposes and should not be construed as indicating relative importance or the quantity of technical features. In the description of the present application, “multiple” means two or more, unless otherwise specifically defined. The following describes the specific implementation of the present application in more detail with reference to specific embodiments.

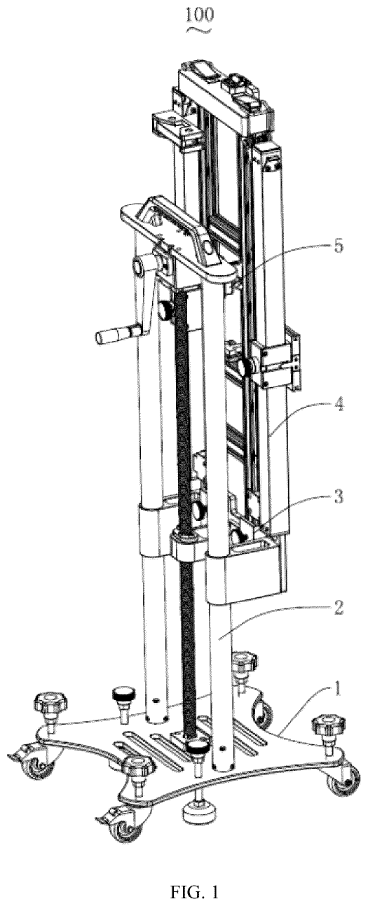

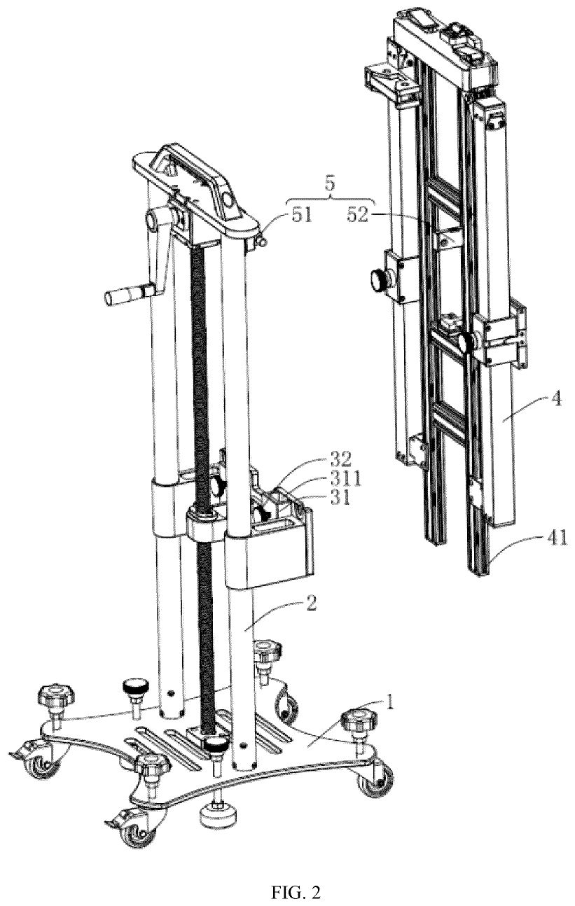

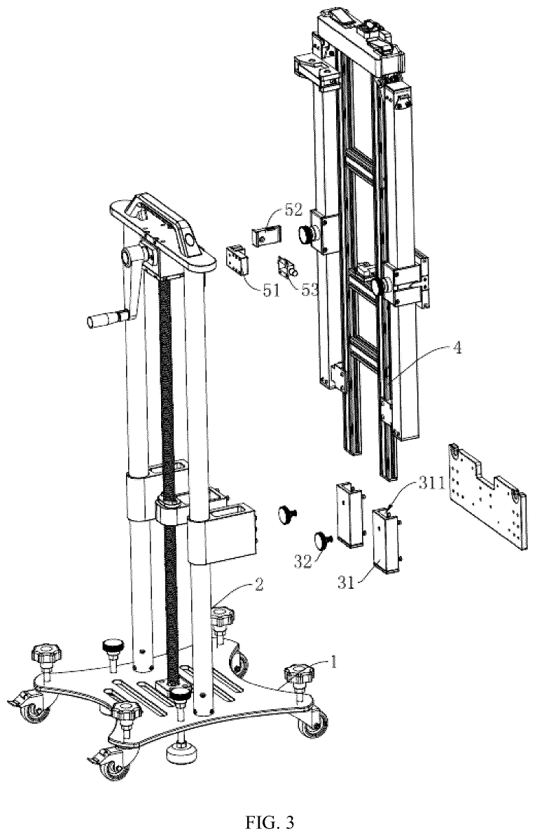

As shown in FIGS. 1 to 3, an embodiment of the present application provides a vehicle calibration device 100 for calibrating a vehicle's onboard devices. The vehicle calibration device 100 is configured to calibrate devices which include, but is not limited to, the vehicle's advanced driver assistance system or four-wheel alignment. The vehicle calibration device 100 of this embodiment has multiple detachable components, which reduces the difficulty of transportation. The following describes the specific implementation.

The vehicle calibration device 100 of this embodiment includes: a base 1, an upright frame 2, a first locking mechanism 3, and a bracket 4.

In this embodiment, the base 1 is configured to be fixed to a calibration site.

The upright frame 2 is provided on the base 1. Here, the upright frame 2 is fixed to the base 1 in an upright position, so that the upright frame 2, when supporting the bracket 4, secures the bracket 4 at a certain height, allowing the bracket 4 to be fixed at the desired calibration height.

The first locking mechanism 3 is provided on the upright frame 2. Here, the first locking mechanism 3 is configured in a detachable connection with the bracket 4, allowing the bracket 4 to be detachably connected to the upright frame 2.

The bracket 4 is configured to be fixed to the first locking mechanism 3 and the bracket 4 is in a detachable connection with the first locking mechanism 3.

The first locking mechanism 3 includes a first locking structure 31 connected to the upright frame 2 and a first locking member 32 provided on the first locking structure 31. The first locking structure 31 has a slot 311, and the bracket 4 has an insertion end 41 for inserting into the slot 311. The first locking member 32 is threadedly connected to the first locking structure 31. The first locking member 32 has a locked state and an unlocked state. When the first locking member 32 is in the locked state, the first locking member 32 is inserted into the slot 311 and abuts against the insertion end 41 to secure the upright frame 2. When the first locking member 32 is in the unlocked state, the first locking member 32 is disengaged from the insertion end 41, allowing the upright frame 2 to be removed from the upright frame 2.

The assembly and disassembly principles of the vehicle calibration device 100 provided in this embodiment are as follows:

The bracket 4 is detachably connected to the upright frame 2 through the first locking mechanism 3.

Specifically, the first locking structure 31 includes a first locking structure 31 and a first locking member 32. The first locking structure 31 is connected to the upright frame 2. The first locking structure 31 has a slot 311, and the first locking member 32 is disposed on the first locking structure 31. The bracket 4 has an insertion end 41 that can be inserted into the slot 311. The first locking member 32 is allowed to slide forward or backward along the slot 311 through the threaded connection with the first locking structure 31. The first locking member 32 may be a bolt. Once the insertion end 41 is inserted into the slot 311, the operator can rotate the first locking member 32 so that the first locking member 32 is inserted into the slot 311 and abuts against the insertion end 41. The friction between the first locking member 32 and the insertion end 41 secures the insertion end 41 with respect to the first locking structure 31, in this way, the bracket (4) is fixed in place on the upright frame 2. Finally, the operator can attach the calibration component to the bracket (4) to perform calibration.

Similarly, the operator rotates the first locking member 32 in the opposite direction, retracting the first locking member 32 from the slot 311 and disengaging the first locking member 32 from the insertion end 41. In this way, the first locking member 32 no longer exerts a force on the insertion end 41, allowing the bracket 4 to be removed from the slot 311, i.e., the connection between the bracket 4 and the upright frame 2 is released. In this way, when transferring the vehicle calibration device 100, the vehicle calibration device 100 can be disassembled into multiple components including the bracket 4 and the upright frame 2, to reduce the maximum weight of individual components, facilitating handling by operators, and lowering the difficulty of transfer.

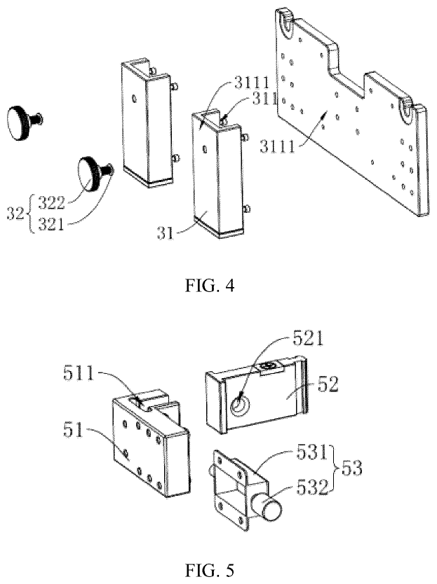

Referring also to FIG. 4, in one embodiment, the slot 311 has two opposing side slot walls 3111. The first locking member 32 is disposed on one of the side slot walls 3111. When the first locking member 32 is inserted into the slot 311 and abuts against the insertion end 41, the first locking member 32 pushes against the insertion end 41, pressing the insertion end 41 against the other side slot wall 3111 of the slot 311.

Here, the insertion end 41 is secured relative to the first locking structure 31 by being clamped between the first locking member 32 and the other side slot wall 3111 of the slot 311. Specifically, when the operator rotates the first locking member 32 so that the first locking member 32 is inserted into the slot 311 and abuts against the insertion end 41, a thrust force is applied to the insertion end 41, pressing the insertion end 41 against the other side slot wall 3111 of the slot 311. At this point, the first locking member 32 and the other side slot wall 3111 of the slot 311 both apply a force on the insertion end 41, securing the bracket 4 relative to the upright frame 2.

It should be further explained that the insertion end 41 of the bracket 4 is inserted into the slot 311 from the notch of the slot 311 along the depth direction of the slot 311. Meanwhile, the extension/retraction direction of first locking member 32 is perpendicular to the depth direction of the slot 311. Consequently, when first locking member 32 presses against insertion end 41, the force applied by the first locking member 32 is perpendicular to the insertion direction of the insertion end 41, enabling the first locking member 32 to securely lock insertion end 41 in position.

By employing the above technical solution, the relative fixation of the bracket 4 and the upright frame 2 is realized.

In one embodiment, a gasket 321 is provided at the end of the first locking member 32 abutting the insertion end 41. The gasket 321 is configured to abut against a surface of the insertion end 41.

Here, the gasket 321 is configured to increase the friction between the first locking member 32 and the insertion end 41. The gasket 321 includes, but is not limited to, a silicone gasket 321 having a high coefficient of friction.

By adopting the above technical solution, the gasket 321 can increase the friction between the first locking member 32 and the insertion end 41, thereby the stability of the first locking member 32 when locking the insertion end 41 is enhanced.

In one embodiment, a locking knob 322 is provided at an end of the first locking member 32 facing away from the first locking structure 31.

Here, the locking knob 322 is coaxial with the first locking member 32, so that rotation of the locking knob 322 drives rotation of the first locking member 32. In addition, the diameter of the locking knob 322 is larger than that of the first locking member 32, allowing the operator to save effort.

By adopting the above technical solution, the operator's difficulty in operating the first locking member 32 is reduced, the physical effort is reduced and the operation efficiency is improved.

In one embodiment, the insertion end 41 is provided with a first locking hole that mates with the first locking member 32. When the first locking member 32 is inserted into the slot 311, the first locking member 32 is inserted into the first locking hole.

Here, when the first locking member 32 is inserted into the first locking hole, the relative movement of the first locking hole is limited by the first locking member 32. This limits the insertion end 41 so that the bracket 4 is fixed relative to the upright frame 2.

By adopting the above technical solution, the cooperative limiting action between the first locking member 32 and the first locking hole enables the bracket 4 to be secured relative to the upright frame 2.

In one embodiment, the end of the first locking member 32 inserted into the first locking hole is threadedly engaged with the first locking hole.

Here, a threaded force generated by the threaded engagement of the first locking member 32 and the first locking hole secures the bracket 4 relative to the upright frame 2.

By employing the above technical solution, the force generated by the threaded connection can enhance the stability of the bracket 4 when secured relative to the upright frame 2.

Referring also to FIG. 5. In one embodiment, the vehicle calibration device 100 further includes a second locking mechanism 5. The second locking mechanism 5 and the first locking mechanism 3 are arranged sequentially along the length direction of the upright frame 2. The second locking mechanism 5 includes a second locking structure 51 provided on the upright frame 2 and a locking block 52 provided on the bracket 4. The second locking structure 51 has a slide groove 511, and the locking block 52 is configured to slide into the slide groove 511 to securely connect the bracket 4 and the upright frame 2.

Here, the second locking mechanism 5 is spaced apart from the first locking mechanism 3 along the length direction of the upright frame 2, and serves to jointly secure the bracket 4 and the upright frame 2. Specifically, the second locking mechanism 5 includes the second locking structure 51 and the locking block 52. The second locking structure 51 is provided on the upright frame 2 and has the slide groove 511. The locking block 52 is provided on the bracket 4. The locking block 52 can move with the bracket 4 and slide into the slide groove 511. Through the limiting effect of the groove wall of the slide groove 511, the locking block 52 is fixedly connected to the second locking structure 51, which thus achieves a fixed connection between the bracket 4 and the upright frame 2.

By employing the above technical solution, the first locking mechanism 3 and the second locking mechanism 5 simultaneously secure the bracket 4 and the upright frame 2, reducing the possibility of the bracket 4 flipping around the first locking mechanism 3 due to the bracket's own weight when secured to the first locking mechanism 3.

In one embodiment, the slide groove 511 is a T-shaped, C-shaped, 7-shaped, or circular groove. The shape of the locking block 52 matches the shape of the slide groove 511, allowing the locking block 52 to slide into the slide groove 511.

By employing the above technical solution, the locking block 52 can fit well with the slide groove 511.

In one embodiment, the second locking mechanism 5 also includes a latch lock 53 provided on the second locking structure 51. The latch lock 53 includes a latch seat 531 and a latch 532 that is retractable from the latch seat 531. The latch 532 can be inserted into the second locking hole 521 of the locking block 52.

Optionally, a length of the latch 532 is perpendicular to an insertion direction of the locking block 52. This allows the latch 532 to provide a supporting force perpendicular to the insertion direction of the locking block 52 when the latch 532 is inserted along the latch's length into the second locking hole 521 of the locking block 52, preventing the locking block 52 from loosening from the slide groove 511.

By employing the above technical solution, the possibility of the locking block 52 loosening from the second locking structure 51 is reduced.

In one embodiment, the latch lock 53 also includes an elastic member connecting the latch seat 531 and the latch 532, the elastic member is used to urge the latch 532 into the second locking hole 521.

By employing the above technical solution, the latch 532 is allowed to automatically insert into the second locking hole 521 when the locking block 52 is inserted into the slide groove 511, eliminating the need for operator intervention and improving the efficiency of assembling the bracket 4 onto the upright frame 2.

The above description illustrates merely some preferred embodiment of the present application and is not intended to limit the present application. Any modifications, equivalent replacements and improvements made within the spirit and principles of the present application should all be included within the protection scope of the present application.

1. A vehicle calibration device, comprising:
a base;
an upright frame provided on the base;
a first locking mechanism provided on the upright frame; and
a bracket, configured to be secured to the first locking mechanism, and the bracket being detachably connected to the first locking mechanism;
wherein the first locking mechanism comprises a first locking structure connected to the upright frame and a first locking member provided on the first locking structure, the first locking structure has a slot, the bracket has an insertion end for insertion into the slot, the first locking member is threadedly connected to the first locking structure, and the first locking member has a locked state and an unlocked state; when the first locking member is in the locked state, the first locking member is inserted into the slot and abuts against the insertion end to secure the upright frame; and when the first locking member is in the unlocked state, the first locking member is disengaged from the insertion end, allowing the upright frame to be removed from the upright frame.

2. The vehicle calibration device according to claim 1, wherein the slot has two side slot walls oppose to each other, and the first locking member is disposed on one of the two side slot walls, when the first locking member is inserted into the slot and abuts against the insertion end, the first locking member pushes against the insertion end, pressing the insertion end against another one of the two side slot walls of the slot.

3. The vehicle calibration device according to claim 2, wherein an end of the first locking member that abuts against the insertion end is provided with a gasket, and the gasket is configured to abut against a surface of the insertion end.

4. The vehicle calibration device according to claim 2, wherein a locking knob is provided at an end of the first locking member facing away from the first locking structure.

5. The vehicle calibration device according to claim 1, wherein the insertion end is provided with a first locking hole that mates with the first locking member, and when the first locking member is inserted into the slot, the first locking member is inserted into the first locking hole.

6. The vehicle calibration device according to claim 5, wherein an end of the first locking member inserted into the first locking hole is threadedly engaged with the first locking hole.

7. The vehicle calibration device according to claim 1, wherein the vehicle calibration device further comprises a second locking mechanism, the second locking mechanism and the first locking mechanism are arranged sequentially along a length direction of the upright frame, the second locking mechanism comprises a second locking structure provided on the upright frame and a locking block provided on the upright frame, the second locking structure has a slide groove, and the locking block is configured to slide into the slide groove to securely connect the bracket and the upright frame.

8. The vehicle calibration device according to claim 7, wherein the slide groove is a T-shaped groove, a C-shaped groove, a 7-shaped t, or a circular groove, and a shape of the locking block matches that of the slide groove, allowing the locking block to slide into the slide groove.

9. The vehicle calibration device according to claim 7, wherein the second locking mechanism further comprises a latch lock provided on the second locking structure, the latch lock comprises a latch seat and a latch retractable from the latch seat, and the latch is capable of being inserted into a second locking hole of the locking block.

10. The vehicle calibration device according to claim 9, wherein the latch lock further comprises an elastic member connecting the latch seat and the latch, wherein the elastic member is configured to drive the latch to be inserted into the second locking hole.

11. The vehicle calibration device according to claim 2, wherein the vehicle calibration device further comprises a second locking mechanism, the second locking mechanism and the first locking mechanism are arranged sequentially along a length direction of the upright frame, the second locking mechanism comprises a second locking structure provided on the upright frame and a locking block provided on the upright frame, the second locking structure has a slide groove, and the locking block is configured to slide into the slide groove to securely connect the bracket and the upright frame.

12. The vehicle calibration device according to claim 3, wherein the vehicle calibration device further comprises a second locking mechanism, the second locking mechanism and the first locking mechanism are arranged sequentially along a length direction of the upright frame, the second locking mechanism comprises a second locking structure provided on the upright frame and a locking block provided on the upright frame, the second locking structure has a slide groove, and the locking block is configured to slide into the slide groove to securely connect the bracket and the upright frame.

13. The vehicle calibration device according to claim 4, wherein the vehicle calibration device further comprises a second locking mechanism, the second locking mechanism and the first locking mechanism are arranged sequentially along a length direction of the upright frame, the second locking mechanism comprises a second locking structure provided on the upright frame and a locking block provided on the upright frame, the second locking structure has a slide groove, and the locking block is configured to slide into the slide groove to securely connect the bracket and the upright frame.

14. The vehicle calibration device according to claim 5, wherein the vehicle calibration device further comprises a second locking mechanism, the second locking mechanism and the first locking mechanism are arranged sequentially along a length direction of the upright frame, the second locking mechanism comprises a second locking structure provided on the upright frame and a locking block provided on the upright frame, the second locking structure has a slide groove, and the locking block is configured to slide into the slide groove to securely connect the bracket and the upright frame.

15. The vehicle calibration device according to claim 6, wherein the vehicle calibration device further comprises a second locking mechanism, the second locking mechanism and the first locking mechanism are arranged sequentially along a length direction of the upright frame, the second locking mechanism comprises a second locking structure provided on the upright frame and a locking block provided on the upright frame, the second locking structure has a slide groove, and the locking block is configured to slide into the slide groove to securely connect the bracket and the upright frame.
